(19) United States
(12) Patent Application Publication
(10) Pub. No.: US 2015/0085438 A1
(43) Pub. Date: Mar. 26, 2015

(54) CAR WASH KIOSK

(71) Applicant: Daniel Aaron Lehman, Decatur, IN (US)

(72) Inventor: Daniel Aaron Lehman, Decatur, IN (US)

(21) Appl. No.: 14/037,289

(22) Filed: Sep. 25, 2013

(51) Int. Cl. G07F 17/20

(52) U.S. Cl. CPC G07F 17/20
USPC 361/679.21

(57) ABSTRACT

A car wash kiosk has components that are easily removable via screws or other fasteners, such as hook and loop fasteners, and that can connect via a plug-in connection, such as USB or a serial connection, for example. Car wash owners, with the car wash kiosk, can easily swap parts without much effort and, thus, focus on washing cars and reducing the time and cost of using vendor technicians to work on the kiosk. By using newer technology with each component, there will no longer be a need to have components soldered together or kiosks cluttered with power supplies, assorted cables and the like. The car wash kiosk enclosure can be custom-design or can be of a standard design, depending on the design desires of the car wash owner.

### CROSS-REFERENCE TO RELATED APPLICATION

This application claims the benefit of priority of U.S. provisional application No. 61/708,193, filed Oct. 1, 2012, the contents of which are herein incorporated by reference.

### BACKGROUND OF THE INVENTION

The present invention relates to a car wash kiosk and, more particularly, to a standard or custom-designed kiosk that uses universal serial bus (USB) or serial technology for the car wash industry.

Car wash owners often want to utilize kiosks to sell car washes or other items. The kiosks may be located in self-service bays, at vacuum stations, or at the front of wash tunnels. The owners do not want to spend time maintaining and supporting the kiosks.

Conventional kiosks do not work well for at least two reasons. First, the car wash owner does not have the opportunity to design their own look for marketing purposes. Second, conventional kiosks are not easily maintained and supported, which could cost a car wash owner significant funds and time when work needs to be performed on the kiosk. If a component (peripheral) fails, the car wash owner or vendor technician must navigate through a plethora or wires and replace components that use older connection technology (such as soldered or welded). This could be difficult and time consuming and this could be days or even weeks before a technician can replace and repair the kiosk.

As can be seen, there is a need for an improved car wash kiosk that can allow owners to quickly and easily replace failed components, upgrade peripherals, and change the overall design of their kiosk.

### SUMMARY OF THE INVENTION

In one aspect of the present invention, a car wash kiosk comprises a kiosk enclosure; a plurality of standard outlets disposed inside the kiosk; a network hub disposed in the kiosk; a computing device connected to the network hub; a display device, connected to the computing device and operable to display to a user outside the kiosk; a plug-and-play hub disposed inside the kiosk enclosure, the plug-and-play hub electrically connected to the network hub; and a plurality of components removably connected to the plug-and-play hub.

In another aspect of the present invention, a car wash kiosk comprises a kiosk enclosure a door hingedly attached to the kiosk enclosure, the door permitting access inside the kiosk enclosure; a plurality of standard outlets disposed inside the kiosk; a network hub disposed in the kiosk; a computing device connected to the network hub; a display device, connected to the computing device and operable to display to a user outside the kiosk; a plug-and-play hub disposed inside the kiosk enclosure, the plug-and-play hub electrically connected to the network hub; and a plurality of components removably connected to the plug-and-play hub, wherein the plurality of components include at least one of a magnetic stripe reader, a bar code reader, a bill dispenser, a bill validator, a coin acceptor, a coin collection box, a coin dispenser, a receipt printer, a gift card dispenser, one or more speakers, a camera, a proximity sensor, a near field communication device, and the like.

These and other features, aspects and advantages of the present invention will become better understood with reference to the following drawings, description and claims.

### BRIEF DESCRIPTION OF THE DRAWINGS

FIG. 1 is a perspective view of a car wash kiosk according to an exemplary embodiment of the present invention;

FIG. 2 is a perspective view of the car wash kiosk of FIG. 1, illustrated with its door open to show internal “plug and play” type components;

FIG. 3 is a cross-sectional view taken along line 3-3 of FIG. 1, illustrated with cords and internal components removed for clarity;

FIG. 4 is a flow chart describing an exemplary embodiment for making the car wash kiosk of FIG. 1;

FIG. 5 is a perspective view of a car wash kiosk according to an alternate embodiment of the present invention; and

FIG. 6 is a perspective view of a car wash kiosk according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a car wash kiosk that has components that are easily removable via screws or other fasteners, such as hook and loop fasteners, and that can connect via a plug-in connection, such as USB or a serial connection, for example. Car wash owners, with the car wash kiosk, can easily swap parts without much effort and, thus, focus on washing cars and reducing the time and cost of using vendor technicians to work on the kiosk. By using newer technology with each component, there will no longer be a need to have components soldered together or kiosks cluttered with power supplies, assorted cables and the like. The car wash kiosk enclosure can be custom-design or can be of a standard design, depending on the design desires of the car wash owner.

The car wash kiosk of the present invention is a significant improvement over current products. First, car wash owners can custom design their own kiosk for appearance or select form standard designs. Second, car wash owners can easily maintain the kiosk and simply replace parts by unscrewing (or removing some fastening device) and disconnecting a connector, such as a USB or serial connector. This is a big improvement over other products that use open-wire power supplies and a large volume of soldered wires. There is currently no known product for self-service bays of for car wash tunnels that use a custom-design enclosure as well as USB/serial plug-and-play components.

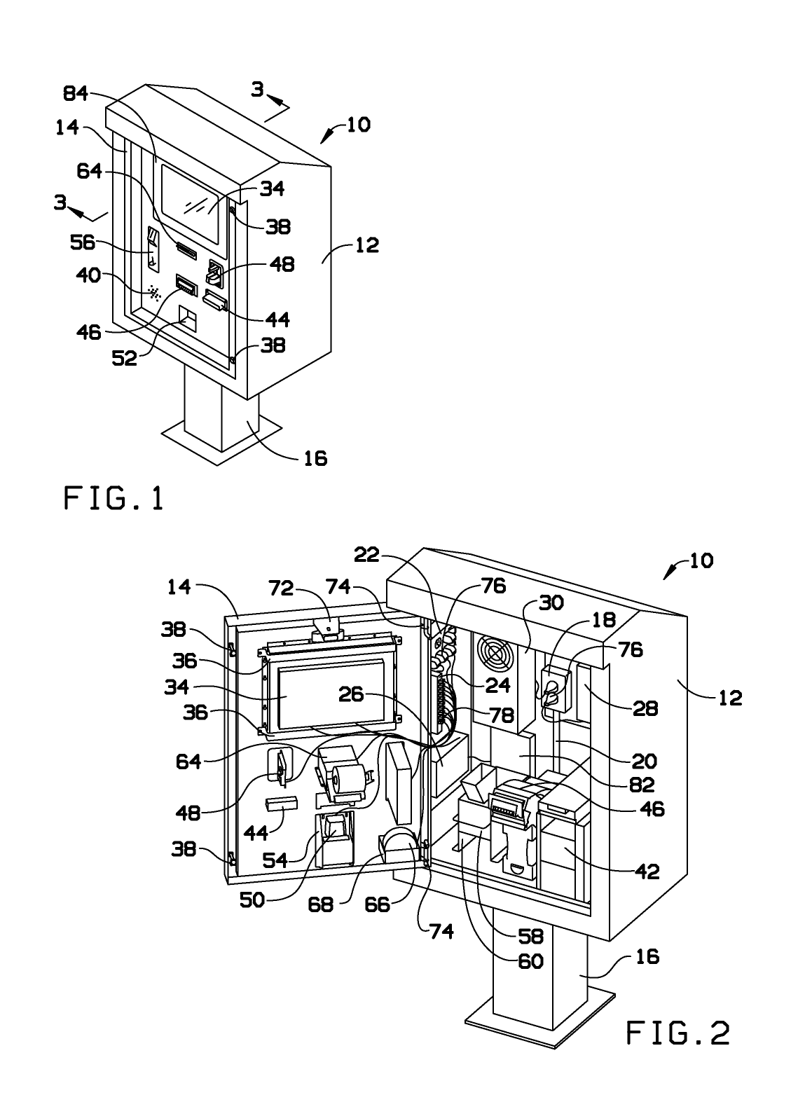

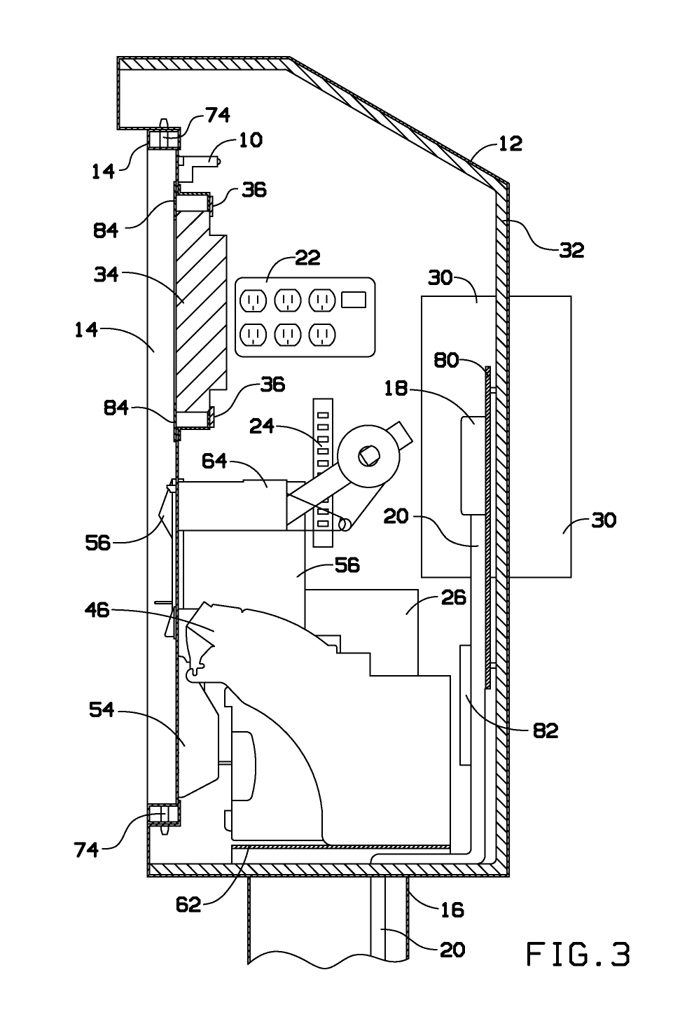

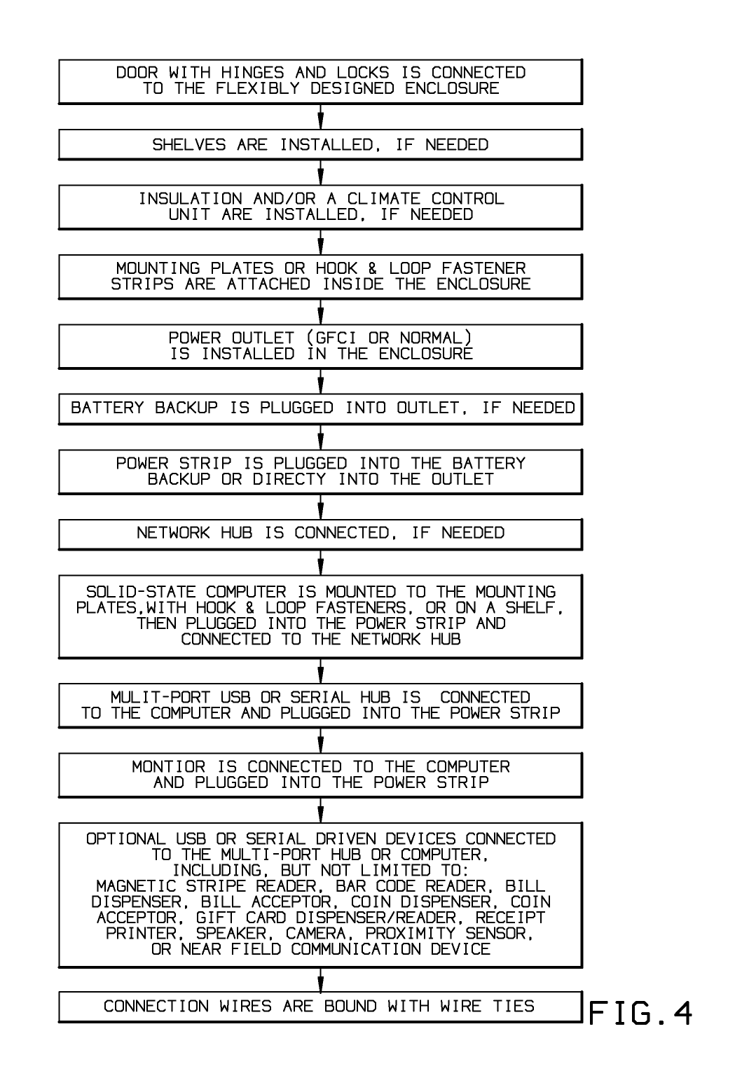

Referring now to FIGS. 1 through 6, a kiosk 10 can include a kiosk enclosure 12 and a door 14. In some embodiments of the present invention, the kiosk enclosure 12 can be supported on a base 16. The door 14, with hinges 74 and locks 38, such as cam locks, is connected to the flexibly-designed enclosure 12 if the enclosure 12 is designed for a door. The enclosure 12 can be powder coated/painted if the kiosk is designed to be finished in such a manner. Decals can be placed on the enclosure and/or the door if the kiosk has decal designs. If needed, an access panel 92 can be provided in the base to access any components that may be stored therein.

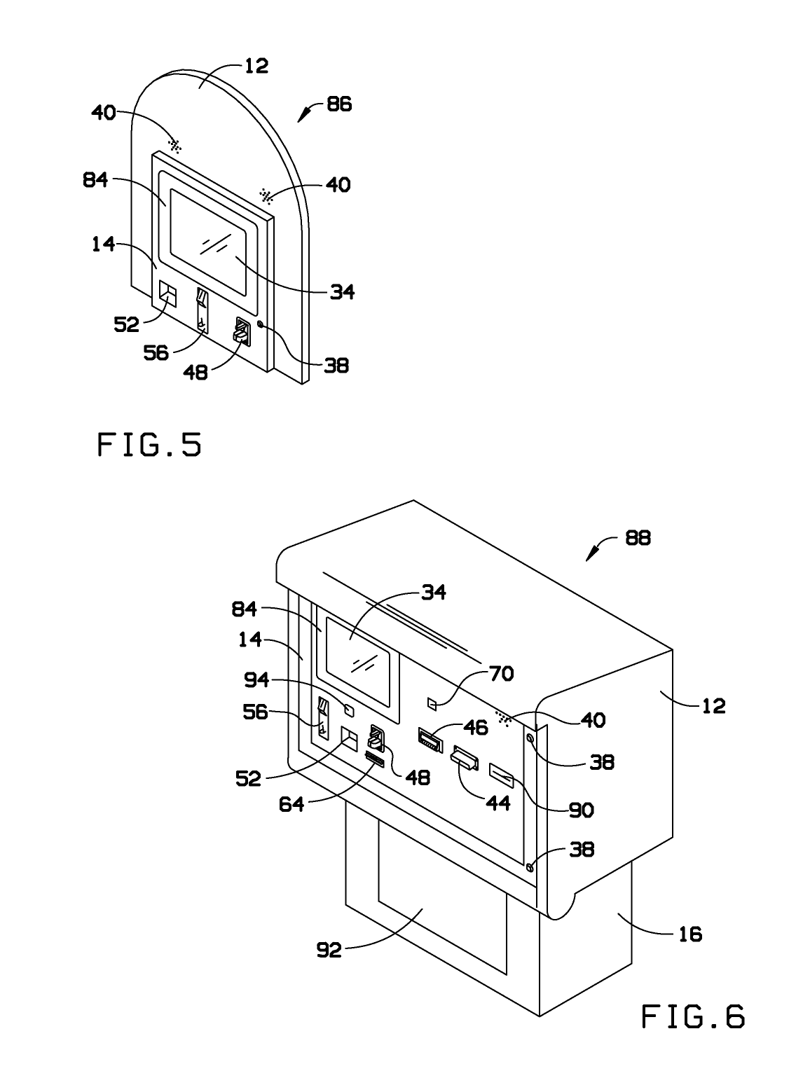

The kiosk 10 can be made in various shapes and sizes. For example, the kiosk can be a small kiosk 86 as shown in FIG. 5 or could be a large kiosk 88 as shown in FIG. 6. In any case, the kiosk can include one or more plug-and-play components/modules as described herein.

Adjustable shelves can be placed in the enclosure 12 if the enclosure is designed for shelves. The enclosure 12 can include insulation 32 on the inside thereof, if needed. A climate control unit 30 can be mounted to the enclosure 12 if a climate control unit is needed based on the environment of the kiosk site. Mounting plates are connected to the enclosure 12 if the enclosure is designed for mounting plates or hook and loop strips (such as Velcro® strips) are connected to the enclosure 12 if the enclosure is designed to use Velcro to mount items.

A power outlet 18 can be mounted to the enclosure 12 to serve as a power source and an external GFC protected wire 20 is connected to the outlet 18. A battery backup 28 can be plugged into the power outlet 18 if the flexible-design calls for a battery backup. A power strip 22 can be plugged into the battery backup 28 or directly to the power outlet 18. A network hub 82 can connected to the network via network cable 78 if needed. A solid state computer 26 can be mounted in the enclosure via mounting plates 80, the adjustable shelves, or the Velcro strips, for example. The computer 26 can be plugged into the power strip 22 and connected to the network hub 82 via the network cable 78 if the hub is needed. A multiport USB or Serial hub 24 can be connected to the solid state computer 26 and a power cord 76 can be plugged into the power strip 22. The climate control unit 30, if installed, can be plugged into the outlet 22.

A monitor 34 can be connected to the computer 26 and plugged into the power strip 18. The monitor 34 can be, for example, a touch screen monitor, allowing the user to touch the monitor to allow for data entry. The monitor 34 can be supported by, for example, monitor braces. The monitor 34 may be framed by a monitor bezel 84 to provide a clean, finished exterior appearance.

Various accessories can be connected to the multiport USB or Serial hub 24 or to the computer 24 via its USB port if the kiosk is designed for the optional items. These accessories can be either USB, serial, or a similar type of plug-and-play design. These accessories can include a magnetic stripe reader 48, a bar code reader 50 (having an associated bar code reader slot 52, and bar code reader housing 54), a bill dispenser 42 (having an associated bill dispenser slot 44), a bill validator 46 supported on, for example, a bill validator shelf 62, a coin acceptor 56, a coin collection box 58 supported, for example, on a coin collection box shelf 60, a receipt printer 64, a gift card dispenser 90, one or more speakers 66 supported on, for example, a speaker shelf 68 and transmitting sound through speaker holes 40, a camera 70 supported by, for example, a camera mounting brace 72, a near field communication device 94, and the like. Of course, the above list is not meant to be exhaustive, and other accessories may be used with the kiosk of the present invention, provided that are designed as plug-and-play modules. Typically, software running on the computer 26 can be updated or enhanced to include drivers to recognize and support each of the various accessories present (or capable of being present, even if not installed) in the kiosk.

Wire ties, or other similar items, can be used to bind all USB and Serial connection wires.

When present, an RFID reader (also referred to as the near field communication device 94) can be connected to the network hub 82 via network cable 78 and powered by the power strip 22 if the design includes RFID technology. The RFID reader can be connected to the RFID antenna (not shown). An optional security system (not shown) can be connected to the network hub 82 via network cable 78 and can be mounted to the enclosure 12 or can be connected to the computer 26 via USB if the design calls for a security system.

When a kiosk user (or customer) approaches the kiosk via car or stand-alone, software begins to interact with the user. The software, which is being executed via the solid state computer 26, may be triggered by a proximity sensor or by the RFID reader. The software will then begin a transaction with the user.

The user can utilize the touch screen monitor to process the transactions. Of course, other user input devices may be present, such as voice recognition, arrows/select buttons, keypads, or the like.

There are a variety of paths the transaction may take that will allow the user to purchase items from the car wash owner. Sound may be used for instruction or for marketing purposes. The camera 70 can be used to record the transaction or to take photos of the user. Items that can be sold may include a gift card, which can be dispensed at the kiosk, a tunnel car wash, a vacuum service, a self-service wash or other miscellaneous items. The person can pay for the items by using cash, coin, gift card, credit card, or near field communications with their phone or tablet or other external electronic device, or other such payments that are known or available to the user. The user may also have prepaid items. Coupons can also be scanned via the bar code scanner or manually entered via the touch screen (or other input device).

Upon completion of the transaction, the software will optionally print a receipt and dispense the necessary change. The software will then communicate with all the external components (gates, a car wash controller, a relay unit or controller, lighting systems, and the like) to provide the service the user desired. When the store owner needs to enter the kiosk, the security system, for example, biometric or touch pad, will be used to physically enter the kiosk, along with associated locking mechanisms.

Described below is one example for making and designing a kiosk according to an exemplary embodiment of the present invention. A user would design or select a suitable enclosure for fabrication using the appropriate metals followed by powder coating and decal application. Based on region and final (indoor or outdoor) location, the user would install the insulation and climate control device followed by mounting the USB or Serial hub and surge protected power supply. Next, the equipment is installed per design as follows: the touchscreen monitor, credit card reader and bar code reader are mounted on the door; the cash acceptor and dispenser, coin/token acceptor and dispenser and gift card dispenser are mounted on the shelf; the computer is either fixed to the enclosure or to the back of the monitor, while the printer, camera, speakers, proximity sensor and near field reader are mounted either to the enclosure, shelf or door. The final assembly includes connections to the USB or Serial hub, electrical connections to the surge protector and network connection to the computer.

The enclosure can take any shape and can be designed to mount on the ground, curb, floor or in a wall. The figures show only a few examples of kiosk design. The enclosure can be designed for internal or external applications. The components can be moved to any location within the enclosure to optimize the customer interface and accessibility. Performance and efficiency will not be diminished as a result of location changes. For example, the credit card reader could be swapped with the cash acceptor if the prevailed method of payment in a given market is via credit or gift cards.

The owner of the car wash would use the kiosk of the present invention to process transactions electronically and also to assist with marketing needs. The owner can use the kiosk of the present invention, that includes commonly connected parts (via USB or Serial Connectors), to easily replace and repair the components without the need to hire outside an outside electrician or other external contractors. All items are easily swapped because of the simple connectors and the openness of the kiosk which has items that are primarily powered by USB peripherals, for example. Power cords are also connected using normal household outlets and not by way of open circuit power boards. Because the kiosk can be designed to the marketing needs (colors, shape, and the like) the owner can further push the brands that he/she desires.

It should be understood, of course, that the foregoing relates to exemplary embodiments of the invention and that modifications may be made without departing from the spirit and scope of the invention as set forth in the following claims.

What is claimed is:

1. A car wash kiosk comprising:
a kiosk enclosure;
a plurality of standard outlets disposed inside the kiosk;
a network hub disposed in the kiosk;
a computing device connected to the network hub;
a display device, connected to the computing device and operable to display to a user outside the kiosk;
a plug-and-play hub disposed inside the kiosk enclosure, the plug-and-play hub electrically connected to the network hub; and
a plurality of components removably connected to the plug-and-play hub.

2. The car wash kiosk of claim 1, further comprising a door hingedly attached to the kiosk enclosure, the door permitting access inside the kiosk enclosure.

3. The car wash kiosk of claim 1, further comprising shelves installed to retain one or more of the plurality of components.

4. The car wash kiosk of claim 1, further comprising climate control mechanisms including at least one of insulation and a climate control unit.

5. The car wash kiosk of claim 1, further comprising at least one mounting plate inside the enclosure.

6. The car wash kiosk of claim 1, further comprising a battery backup adapted to power the plurality of standard outlets.

7. The car wash kiosk of claim 1, wherein the plurality of components include at least one of a magnetic stripe reader, a bar code reader, a bill dispenser, a bill validator, a coin acceptor, a coin collection box, a receipt printer, a gift card dispenser, one or more speakers, a camera, a gift card dispenser, a near field communication device.

8. A car wash kiosk comprising:
a kiosk enclosure a door hingedly attached to the kiosk enclosure, the door permitting access inside the kiosk enclosure;
a plurality of standard outlets disposed inside the kiosk;
a network hub disposed in the kiosk;
a computing device connected to the network hub;
a display device, connected to the computing device and operable to display to a user outside the kiosk;
a plug-and-play hub disposed inside the kiosk enclosure, the plug-and-play hub electrically connected to the network hub; and
a plurality of components removably connected to the plug-and-play hub, wherein the plurality of components include at least one of a magnetic stripe reader, a bar code reader, a bill dispenser, a bill validator, a coin acceptor, a coin collection box, a receipt printer, a gift card dispenser, one or more speakers, a camera, a gift card dispenser, a near field communication device.

9. The car wash kiosk of claim 8, further comprising one or more mounting mechanisms disposed inside the kiosk, the one or more mounting mechanisms operable to support the plurality of components.

10. The car wash kiosk of claim 8, further comprising a battery backup adapted to power the plurality of standard outlets.
